(19) United States
(12) Patent Application Publication
(10) Pub. No.: US 2011/0198934 A1
(43) Pub. Date: Aug. 18, 2011

(54) PHOTOVOLTAIC POWER SYSTEM

(76) Inventor: Hirofumi Mitsuoka, Osaka (JP)

(21) Appl. No.: 13/123,948

(22) PCT Filed: Oct. 6, 2009
(86) PCT No.: PCT/JP2009/067370

§ 371 Date: Apr. 13, 2011

(30) Foreign Application Priority Data
Oct. 14, 2008 (JP) 2008-265734
Oct. 14, 2008 (JP) 2008-265747

(51) Int. Cl. H02J 1/12; H02J 9/00

(52) U.S. Cl. 307/66; 307/82

(57) ABSTRACT

A photovoltaic power system comprising: a plurality of photovoltaic power units each of which includes: a solar battery unit in which high-voltage output solar battery modules are connected in parallel with each other; and a conversion portion that converts a direct-current voltage output from the solar battery unit; and at least one transmission line which is disposed in parallel with the plurality of photovoltaic power units and to which each of the plurality of photovoltaic power units is connected.

### TECHNICAL FIELD

The present invention relates to a photovoltaic power system, more particularly, to a type of photovoltaic power system that is composed of a plurality of solar battery modules, disposed along a transmission line and generates power; and to a type of a photovoltaic power system that consecutively disposes solar battery units each of which is composed of a plurality of solar battery modules along an expressway or the like to generate power.

### BACKGROUND ART

As a photovoltaic power system, a type of photovoltaic power system, in which disposes a plurality of solar battery modules are disposed into an array shape on a land to generate power, is general; however, in a case where a plurality of solar battery modules are disposed into an array shape on a mass of land to generate power, a larger-scale power generation needs a vaster mass of land and it becomes hard to secure such a land. In contrast, a type of photovoltaic power system, which disposes a solar battery unit composed of a plurality of solar battery modules along an expressway or the like to generate power, is proposed. For example, a patent document 1 is characterized in that output of an inverter is connected to an existing distribution line for a road illumination light. Besides, for example, the patent document 1 describes that solar battery units each of which is composed of a plurality of solar battery modules are consecutively disposed along an expressway or the like.

### CITATION LIST

### Patent Literature

PLT1: JP-A-1996-126224
PLT2: JP-A-1989-238440
PLT3: JP-A-2008-118845

### SUMMARY OF INVENTION

### Technical Problem

In the type of photovoltaic power system in which a solar battery unit composed of a plurality of solar battery modules is disposed along an expressway or the like to generate power, to form the solar battery unit into an elongate shape, a cable for connecting the solar battery unit and a conversion apparatus such as an inverter apparatus and the like to each other tends to become long; and power loss in the cable becomes a problem.

Besides, in the type of photovoltaic power system in which solar battery units, each of which is composed of a plurality of solar battery modules, are consecutively disposed along an expressway or the like to generate power, a length of a transmission line, which is disposed in parallel with the plurality of photovoltaic power units and to which each of the plurality of photovoltaic power units is directly or indirectly connected, becomes long, so that power loss in the transmission line becomes a problem.

In light of the above circumstances, it is a first object of the present invention to provide a photovoltaic power system that is able to reduce power loss in a cable that connects a solar battery unit and a conversion apparatus such as an inverter apparatus and the like to each other.

Because, in light of the above circumstances, it is a second object of the present invention to provide a photovoltaic power system that is able to reduce power loss in a transmission line which is disposed in parallel with a plurality of photovoltaic power units and to which each of the plurality of photovoltaic power units is directly or indirectly connected.

### Solution to Problem

To achieve the above first object, a photovoltaic power system according to an aspect of the present invention includes:

a plurality of photovoltaic power units each of which includes:
a solar battery unit in which high-voltage output solar battery modules are connected in parallel with each other; and
a conversion portion that converts a direct-current voltage output from the solar battery unit; and

at least one transmission line which is disposed in parallel with the plurality of photovoltaic power units and to which each of the plurality of photovoltaic power units is connected.

To achieve the above second object, a photovoltaic power system according to another aspect of the present invention includes:

a plurality of photovoltaic power units each of which includes:
a solar battery unit in which a plurality of solar battery modules are are connected to each other; and
a conversion portion that converts a direct-current voltage output from the solar battery unit; and

one or more transmission lines which are disposed in parallel with the plurality of photovoltaic power units and to which each of the plurality of photovoltaic power units is connected;

wherein at least one of the transmission lines is a super-conducting cable.

According to this structure, the super-conducting cable is used as the at least one of the transmission lines which are disposed in parallel with the plurality of photovoltaic power units and to which each of the plurality of photovoltaic power units is connected, so that it is possible to reduce power loss in the at least one transmission line to which each of the plurality of photovoltaic power units is directly or indirectly connected.

Besides, it is desirable that the photovoltaic power system includes a refrigerant supply apparatus that supplies a refrigerant to the super-conducting cable; wherein as power for the refrigerant supply apparatus, a direct-current voltage output from the solar battery unit is used. And, in this case, it is desirable that part of the plurality of photovoltaic power units are photovoltaic power units that have a load; and the rest of the plurality of photovoltaic power units are photovoltaic power units that do not have a load. According to this structure, it is possible to secure the power for the refrigerant supply apparatus with the generated power from the photovoltaic power units that do not have a load.

Besides, it is desirable that each of the plurality of photovoltaic power units includes an accumulation device. According to this, even in a case where transmission trouble occurs in the transmission line, each of the plurality of photovoltaic power units is able to secure independent power.

Besides, to allow existing facilities (an alternating-current transmission line, a transformer and the like) to be used, it is desirable that the conversion portion is an inverter apparatus.

Besides, it is desirable that one of the transmission lines is a first transmission line, and another of the transmission lines is a second transmission line; wherein the second transmission line transmits a voltage higher than a voltage transmitted by the first transmission line, and is a super-conducting cable.

Besides, it is desirable that the conversion portion may be a DC/DC converter, and the transmission line may be a direct-current transmission line.

### Advantageous Effects of Invention

In the structure of the photovoltaic power system according to the one aspect of the present invention, the solar battery unit in which the high-voltage output solar battery modules are connected in parallel with each other is used, so that it is possible to reduce the arrangements of cables that connect the solar battery unit and the conversion apparatus such as the inverter apparatus and the like to each other. According to this, it is possible to achieve reduction in the power loss in the cable that connects the solar battery unit and the conversion apparatus such as the inverter apparatus to each other.

In the structure of the photovoltaic power system according to the other aspect of the present invention, the super-conducting cable is used as the at least one of the transmission lines which are disposed in parallel with the plurality of photovoltaic power units and to which each of the plurality of photovoltaic power units is connected, it is possible to achieve reduction in the power loss in the at least one transmission line which is disposed in parallel with the plurality of photovoltaic power units and to which each of the plurality of photovoltaic power units is connected directly or indirectly.

### BRIEF DESCRIPTION OF DRAWINGS

FIG. 1 is a diagram showing a schematic structure of a photovoltaic power system according to a first embodiment of the present invention.

FIG. 2 is a diagram showing a structural example of a solar battery unit of the photovoltaic power system shown in FIG. 1 and FIG. 7.

FIG. 3 is a diagram showing a structural example of a solar battery unit that uses a crystalline solar battery module.

FIG. 4 is a diagram showing a schematic structure of a photovoltaic power system according to a second embodiment of the present invention.

FIG. 5 is a diagram showing a schematic structure of a photovoltaic power system according to a third embodiment of the present invention.

FIG. 6 is a diagram showing a schematic structure of a photovoltaic power system according to a fourth embodiment of the present invention.

FIG. 7 is a diagram showing a schematic structure of a photovoltaic power system according to a fifth embodiment of the present invention.

FIG. 8 is a diagram showing another structural example of a solar battery unit of the photovoltaic power system shown in FIG. 7.

FIG. 9 is a diagram showing a schematic structure of a photovoltaic power system according to a sixth embodiment of the present invention.

FIG. 10 is a diagram showing a schematic structure of a photovoltaic power system according to a seventh embodiment of the present invention.

### DESCRIPTION OF EMBODIMENTS

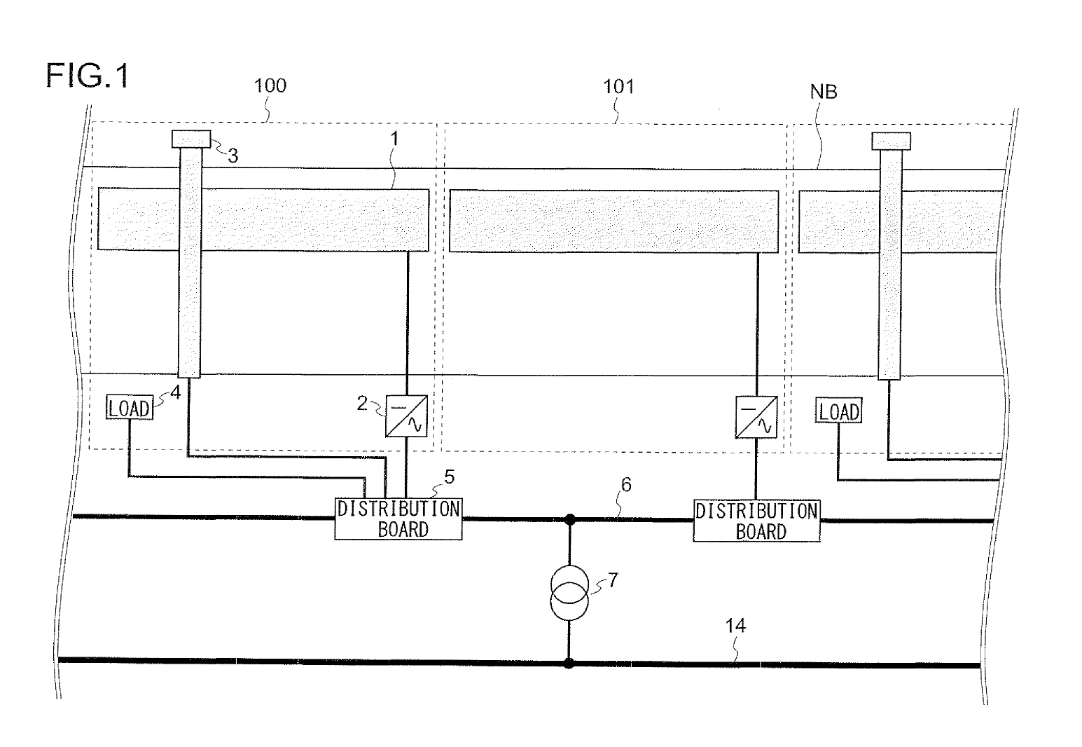

Embodiments of the present invention are described hereinafter with reference to the drawings. A schematic structure of a photovoltaic power system according to a first embodiment of the present invention is shown in FIG. 1.

The photovoltaic power system according to the first embodiment of the present invention shown in FIG. 1 includes:

a plurality of photovoltaic power units 100 each of which has: a solar battery unit 1; an inverter apparatus 2 that converts a direct-current, that is, d.c. voltage output from the solar battery unit 1 into an alternating-current, that is, a.c. voltage; a load (e.g., an illumination light and the like) 3; and a load (e.g., an indication light and the like) 4; and

a plurality of photovoltaic power units 101 each of which includes: the solar battery unit 1; the inverter apparatus 2 that converts the d.c. voltage output from the solar battery unit 1 into the a.c. voltage. The photovoltaic power units 100, 101 are disposed on, for example, a sound-proof wall NB of an expressway along a longitudinal direction of the solar battery unit 1; a predetermined number (e.g., 9) of the photovoltaic power units 100 are consecutively arranged; one photovoltaic power unit 101 is interposed; and further, a predetermined number (e.g., 9) of the photovoltaic power units 100 are consecutively arranged, which is repeated.

Besides, the photovoltaic power system according to the first embodiment of the present invention shown in FIG. 1 includes: a distribution board 5 that is connected to the inverter apparatus 2, the load 3 and the load 4 of the photovoltaic power unit 100, or connected to the inverter apparatus 2 of the photovoltaic power unit 101; and a 400 VAC transmission line 6 that is connected to the inverter apparatus 2, the load 3 and the load 4 of the photovoltaic power unit 100 via the distribution board 5 and connected to the inverter apparatus 2 of the photovoltaic power unit 101 via the distribution board 5.

Further, the photovoltaic power system according to the first embodiment of the present invention shown in FIG. 1 includes a transformer 7 having a rated capacity of 150 kVA that transforms a voltage from the 400 VAC transmission line 6 into a high voltage to supply the high voltage to a high-voltage transmission line 14; and transforms a voltage from the high-voltage transmission line 14 into a low voltage to supply the low voltage to the 400 VAC transmission line 6. Here, the high-voltage transmission line 14 functions as a transmission line that has the purpose of transmitting power such as 6600 VAC or 22 kVAC, for example, to a distant place.

In a case where the sunshine impinges on the solar battery unit 1 and the photovoltaic power units 100, 101 generate power in a good-weather daytime, the generated power from the photovoltaic power units 100, 101 successively passes through the distribution board 5, the 400 VAC transmission line 6, the transformer 7, and the high-voltage transmission line 14, so that the generated power is transmitted to other power consuming places by the 400 VAC transmission line 6, the high-voltage transmission line 14 and the like. Here, in a case where the load 4 is a load that consumes power even in the good-weather daytime, power generated from the photovoltaic power unit 100 is transmitted to the load 4 as well. On the other hand, in a case where the sunshine does not impinge on the solar battery unit 1 and the photovoltaic power units 100, 101 do not generate power at night or in a bad-weather daytime, power from a power plant and the like successively passes through the high-voltage transmission line 14, the transformer 7, the 400 VAC transmission line 6, and the distribution board 5, so that the power is supplied to the load 3 and the load 4.

It is desirable that the inverter apparatus 2 has a maximum-power point tracking function; and in the present embodiment, it is supposed that the inverter apparatus 2 has the maximum-power point tracking function. In a case where the inverter apparatus 2 performs the maximum-power point tracking control, if many photovoltaic power units 100, 101 are connected to the 400 VAC transmission line 6, voltage increase in the 400 VAC transmission line 6 due to voltages output from the many photovoltaic power units 100, 101 becomes a problem. To curb this voltage increase, grids are disposed at predetermined intervals on the 400 VAC transmission line 6. Here, if the high-voltage solar battery module is disposed in parallel with the transmission line, it is possible to efficiently collect the generated power along the transmission line and to achieve reduction in the power loss. Further, it is possible to curb the voltage increase with every grid by connecting the transmission line to the high-voltage transmission line, and it is possible to prevent the transmission efficiency from the inverter apparatus 2 from dropping and achieve reduction in the power loss.

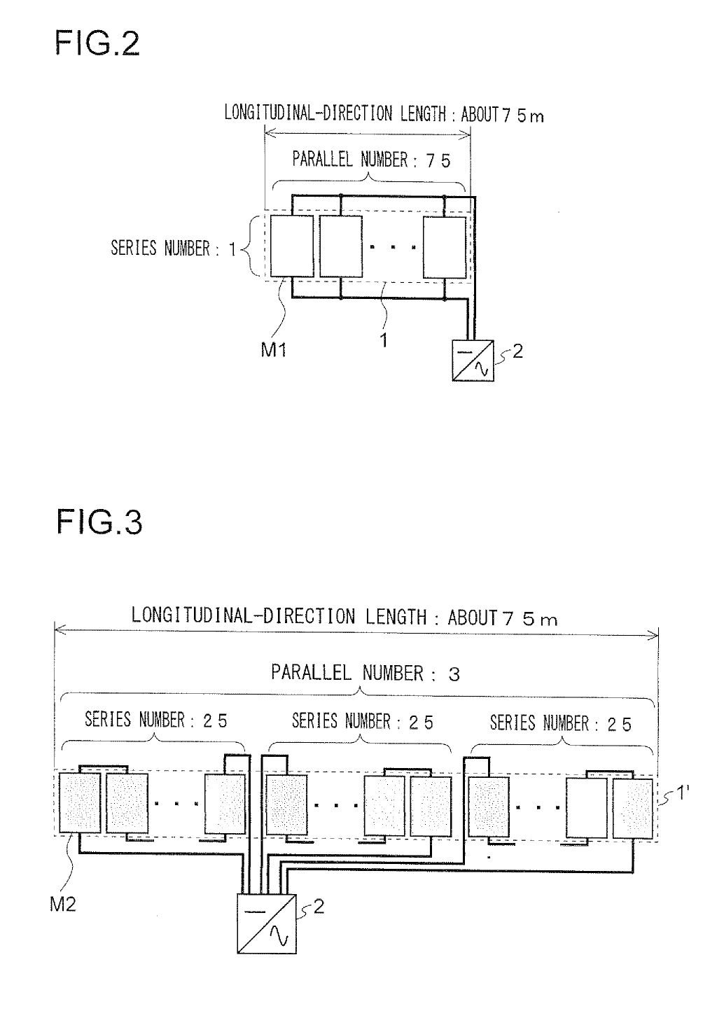

Next, a structural example of the solar battery unit 1 is described with reference to FIG. 2. In the structural example shown in FIG. 2, the solar battery unit 1 has 75 high-voltage output thin-film solar battery modules M1 that has an open-circuit voltage of 240 V or higher; the 75 high-voltage output thin-film solar battery modules M1 are connected into an arrangement with a series number of 1 and a parallel number of 75; and a parallel direction of the high-voltage output thin-film solar battery module M1 is the longitudinal direction of the solar battery unit 1. And, the solar battery unit 1 and the inverter 2 are connected to each other via a connection cable.

In the case where the solar battery unit is composed of the high-voltage output thin-film solar battery module, as in the structural example shown in FIG. 2, it is necessary to decrease the series number to prevent the open-circuit voltage of the solar battery unit from becoming larger than an upper limit of a predetermined range. Here, the predetermined range is set in accordance with the requirements of a conversion apparatus (e.g., an inverter apparatus) that converts an output voltage from the solar battery unit.

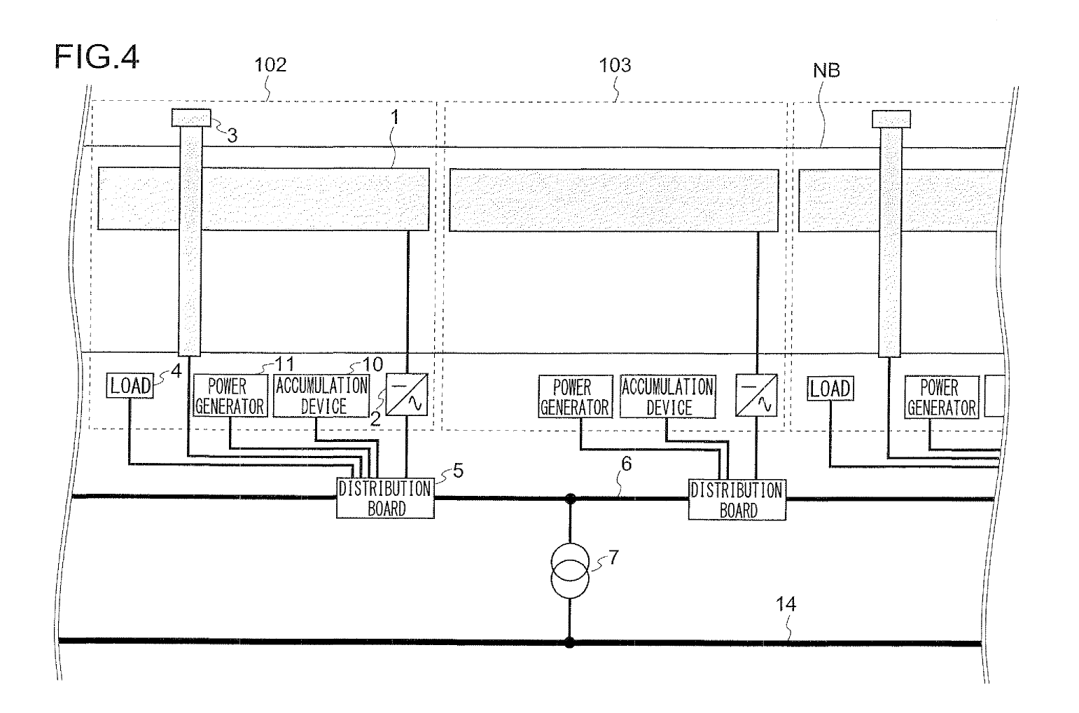

Here, for comparison, a structural example, in which the solar battery unit is composed of a crystalline solar battery module M2 that is a low-voltage output solar battery module and has an open-circuit voltage of about 20 V, is shown in FIG. 3. In the structural example shown in FIG. 3, a solar battery unit 1′ has 75 crystalline solar battery modules M2; the 75 crystalline solar battery modules M2 are arranged in a line; the 75 crystalline solar battery modules M2 are connected into an arrangement with a series number of 25 and a parallel number of 3; and a direction in which the 75 crystalline solar battery modules M2 are arranged in the line is a longitudinal direction of the solar battery unit 1′. And, the solar battery unit 1′ and the inverter apparatus 2 are connected to each other by a cable.

In the case where the solar battery unit is composed of the crystalline solar battery module, as in the structural example shown in FIG. 3, it is necessary to increase the series number to prevent the open-circuit voltage of the solar battery unit from becoming smaller than a lower limit of a predetermined range. Here, the predetermined range is set in accordance with the requirements of a conversion apparatus (e.g., an inverter apparatus) that converts the output voltage from the solar battery unit.

In the structural example shown in FIG. 3, the 3 parallel groups in the solar battery unit 1′ are arranged in a line, so that the arrangements of the connection cables that connect the solar battery unit 1′ and the inverter 2 to each other become more than the structural example shown in FIG. 2; and the power loss increases more than the structural example shown in FIG. 2. In other words, as in the present invention, for example, by composing the solar battery unit by means of the high-voltage output thin-film solar battery module that has the open-circuit voltage of 240 V, the arrangements of the cables, which connect the solar battery unit and the conversion apparatus (e.g., the inverter apparatus) that converts the output voltage from the solar battery unit to each other, become less than the structure in which the solar battery unit is composed of the crystalline solar battery module, so that it is possible to reduce the power loss.

As for the high-voltage output solar battery module used in the present invention, for example, in a case of a commercial system voltage of 200 V, in the photovoltaic power system according to the present invention, a high-voltage output solar battery module having the open-circuit volt of 240 V or higher is preferable in consideration of a voltage drop due to a resistor of a power line from the commercial system voltage; and, for example, it is preferable to employ a structure, which includes:

a plurality of photovoltaic power units each of which has: a solar battery unit in which N (N is an integer that is 2 or more) thin-film solar battery modules as the high-voltage output solar battery modules are connected into an arrangement with a series number of 1 and a parallel number of N; and a conversion portion that converts a d.c. voltage output from the solar battery unit;

the plurality of photovoltaic power units are disposed along the longitudinal direction of the solar battery unit that is the parallel direction of the high-voltage output thin-film solar battery module; and

at least one transmission line which is disposed in parallel with the plurality of photovoltaic power units and to which each of the plurality of photovoltaic power units is connected.

According to this structure, the solar battery unit in which the N (N is an integer that is 2 or more) high-voltage output thin-film solar battery modules each of which has the open-circuit voltage of 240 V or higher are connected into the arrangement with the series number of 1 and the parallel number of N, so that it is possible to reduce the arrangements of the cables that connect the solar battery unit and the conversion apparatus such as the inverter apparatus and the like to each other. According to this, it is possible to achieve reduction in the power loss in the cable that connects the solar battery unit and the conversion apparatus such as the inverter apparatus and the like to each other.

The case where the series number of the solar battery modules is 1 is described above; however, it is possible to reduce the arrangements of the cables by connecting, for example, the solar battery modules, which has the series number of 2 or more, in parallel with each other in a transmission line direction to obtain the high-voltage output.

Besides, it is desirable that at least one of the transmission lines is a super-conducting cable; in the ease where a super-conducting cable is used as the at least one of the transmission lines, it is desirable that a refrigerant supply apparatus which supplies a refrigerant to the super-conducting cable is employed; and as power for the refrigerant supply apparatus, the d.c. voltage output from the solar battery unit is used. And, in this case, it is desirable that part of the plurality of photovoltaic power units are photovoltaic power units that have a load; and the rest of the plurality of photovoltaic power units are photovoltaic power units that do not have a load. According to this structure, it is possible to secure the power for the refrigerant supply apparatus with power generated from the from the photovoltaic power units that do not have a load.

Beside, it is desirable that each of the plurality of photovoltaic power units includes an accumulation device or a power facility. According to this, even in a case where transmission trouble occurs in the transmission line, each of the plurality of photovoltaic power units is able to secure independent power.

Besides, from the viewpoint for reducing the transmission loss, the conversion portion may be a DC/DC converter; and the transmission line may be a d.c. transmission line.

According to the above structure, for example, the solar battery unit in which the N (N is an integer that is 2 or more) high-voltage output thin-film solar battery modules, each of which has the open-circuit voltage of 240 V, are connected into the arrangement with the series number of 1 or more and the parallel number of N, so that it is possible to reduce the arrangements of the cables that connect the solar battery unit and the conversion apparatus such as the inverter apparatus and the like to each other. According to this, it is possible to achieve reduction in the power loss in the cable that connects the solar battery unit and the conversion apparatus such as the inverter apparatus and the like to each other.

In the above photovoltaic power system according to the first embodiment of the present invention shown in FIG. 1, in a case where transmission trouble occurs in the 400 VAC transmission line 6 and the high-voltage transmission line 14, there is a problem that it is impossible to secure the power for the load 3 and the load 4. A photovoltaic power system according to an embodiment of the present invention that is able to solve the problem is shown in FIG. 4. Here, in FIG. 4, the same portions as those in FIG. 1 are indicated by the same reference numbers and detailed description is skipped.

The photovoltaic power system according to a second embodiment of the present invention shown in FIG. 4 has a structure in which in the photovoltaic power system according to the first embodiment of the present invention shown in FIG. 1, the photovoltaic power unit 100 is replaced with a photovoltaic power unit 102; and the photovoltaic power unit 101 is replaced with a photovoltaic power unit 103.

The photovoltaic power unit 102 has a structure in which an accumulation device 10 and a power generator (e.g., a Diesel-engine generator) 11 are added to the photovoltaic power unit 100; and the photovoltaic power unit 103 has a structure in which the accumulation device 10 and the power generator (e.g., the Diesel-engine generator) 11 as a power facility are added to the photovoltaic power unit 101. The accumulation device 10 and the power generator 11 are connected to the distribution board 5 as shown in FIG. 4.

In the photovoltaic power unit 102, the accumulation device 10 accumulates the generated power from the solar battery unit 1; and supplies power to the load 3 and the load 4 by discharge when the load 3 and the load 4 consume power. Besides, the power generator 11 operates in a case where the accumulated power in the accumulation device 10 runs out. According to this, even in a case where transmission trouble occurs in the 400 VAC transmission line 6 or the high-voltage transmission line 14, it is possible to secure the power for the load 3 and the load 4.

Besides, if the photovoltaic power unit interacts with a load or a power facility at a plurality of points via the transmission line or the high-voltage transmission line, it is possible to perform more stable power supply and power transmission; and it is possible to achieve reduction in the power loss.

Besides, if an accumulator or a power facility is disposed in parallel with the solar battery unit, it becomes possible to perform stable power supply and power transmission by means of every unit; and it is possible to achieve reduction in the power loss.

In the photovoltaic power unit 103, the accumulation device 10 accumulates the generated power from the solar battery unit 1; and supplies power to a distribution control portion (not shown) of a distribution board via the distribution board 5, the 400 VAC transmission line 6, and the transformer 7. Besides, the power generator 11 operates in a case where the accumulated power in the accumulation device 10 runs out. According to this, even in a case where transmission trouble occurs in the 400 VAC transmission line 6 or the high-voltage transmission line 14, as long as there is not transmission trouble in the connection route between the photovoltaic power unit 103 and the transformer 7, it is possible to secure the power for the distribution control. Hereinbefore, the example is described, in which the distribution control is performed with the distribution board; however, if it is possible to perform the distribution control with another apparatus other than the distribution board, the place is not limited.

Here, in the system operation, if there is not a risk in effect that the accumulated power in the accumulation device 10 runs out, it is unnecessary to dispose the power generator 11, so that a structure, in which each photovoltaic power unit does not include the power generator 11, may be employed. As described above, by performing the distribution control by means of power from any of the system power supply, the solar battery unit, the accumulator and the power facility via the transmission line, it becomes possible to perform stable power supply and power transmission; and it is possible to achieve reduction in the power loss.

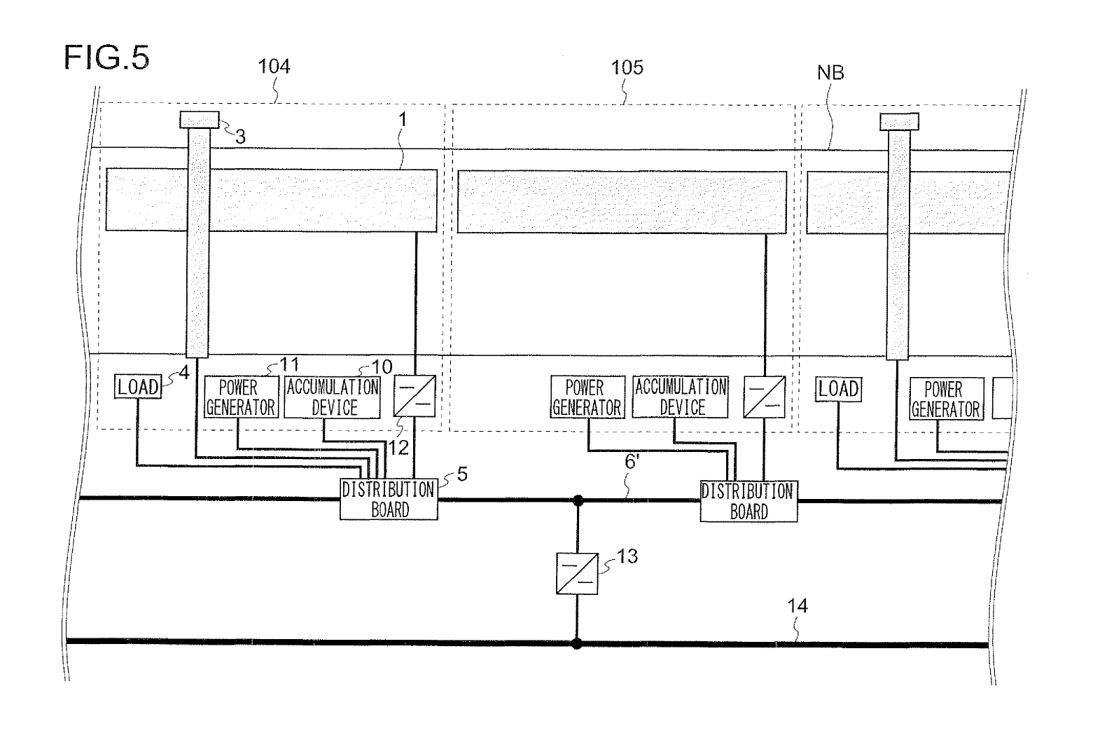

The above photovoltaic power systems according to the first and second embodiments employ the a.c. transmission; however, d.c. transmission may be employed form the viewpoint for reducing the power loss. A photovoltaic power system according to a third embodiment of the present invention that employs the d.c. transmission is shown in FIG. 5. Here, in FIG. 5, the same portion as those in FIG. 4 are indicated by the same reference numbers and detailed description is skipped.

The photovoltaic power system according to the third embodiment of the present invention shown in FIG. 5 has a structure in which in the photovoltaic power system according to the second embodiment of the present invention shown in FIG. 4, the photovoltaic power unit 102 is replaced with a photovoltaic power unit 104; the photovoltaic power unit 103 is replaced with a photovoltaic power unit 105; the 400 VAC transmission line 6 is replaced with a 400 VDC transmission line 6′; and the transformer 7 is replaced with a DC/DC converter 13. Here, in the photovoltaic power system according to the third embodiment of the present invention shown in FIG. 5, the high-voltage transmission line functions as a 22 kVDC transmission line.

The photovoltaic power unit 104 has a structure in which the inverter apparatus 2 of the photovoltaic power unit 102 is replaced with a DC/DC converter 12; and the photovoltaic power unit 105 has a structure in which the inverter apparatus 2 of the photovoltaic power unit 103 is replaced with the DC/DC converter 12.

In the photovoltaic power system according to the third embodiment of the present invention shown in FIG. 5, the accumulation device 10 receives a d.c. voltage, so that compared with the case of the photovoltaic power system according to the second embodiment of the present invention shown in FIG. 4, the specific structure of the accumulation device 10 becomes simple. On the other hand, in the photovoltaic power system according to the third embodiment of the present invention shown in FIG. 5, the power generator 11 needs to output a d.c. voltage, so that compared with the case of the photovoltaic power system according to the second embodiment of the present invention shown in FIG. 4, the specific structure of the power generator 11 becomes complicated.

Besides, instead of the high-voltage transmission line 14, a super-conducting cable 9 may be used.

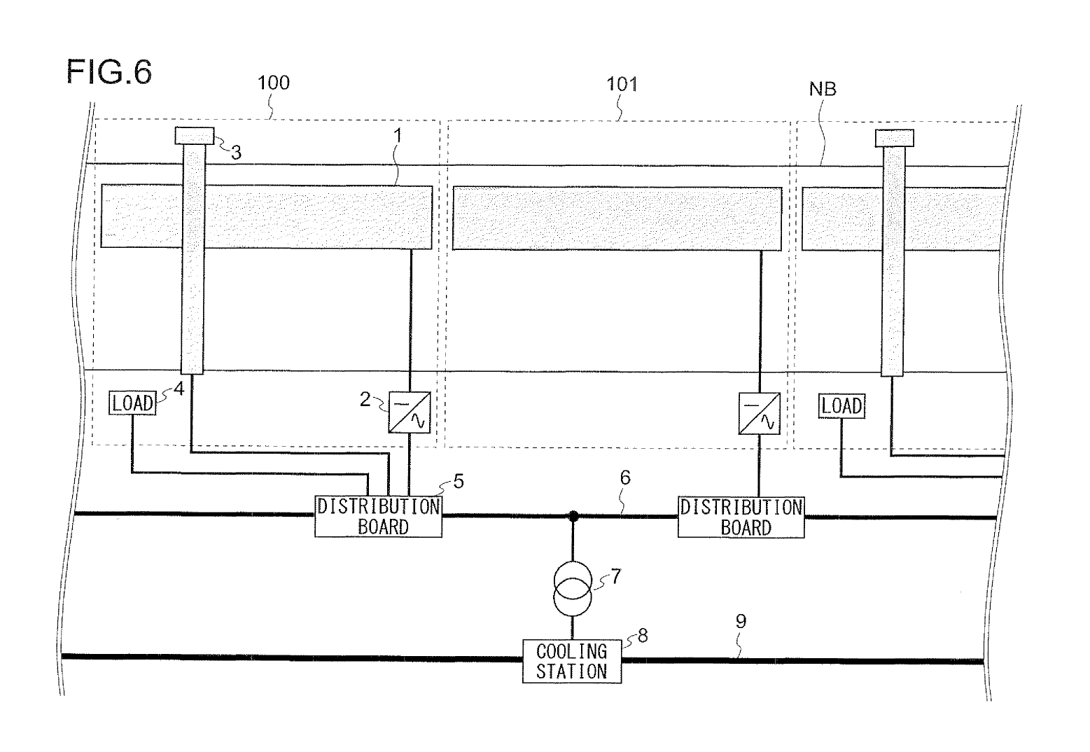

A cooling station 8 in a case where a super-conducting cable is used as at least one of the transmission lines is described. The cooling station 8 has a pressure pump or a circulating pump (not shown) that supplies a liquefied gas (e.g., liquid nitrogen) to the super-conducting cable 9. In the photovoltaic power system according to a fourth embodiment of the present invention shown in FIG. 6, as power for the above pressure pump or the above circulating pump, power generated from the photovoltaic power units 100, 101 is used. In other words, the above pressure pump or the above circulating pump is supplied with the power from the high-voltage side of the transformer 7.

In a case where the load 4 is a load that consumes power even in a good-weather daytime, power generated from the photovoltaic power unit 100 is transmitted to the load 4 as well; however, the photovoltaic power unit 101 has no loads, so that there is not a risk that power is consumed by a load in the photovoltaic power unit. Because of this, by periodically disposing the photovoltaic power unit 101 like the photovoltaic power system according to the fourth embodiment of the present invention shown in FIG. 6, it is possible to secure the power for the above pressure pump or the above circulating pump with power generated from the photovoltaic power unit 101.

However, in a case where the sunshine does not impinge on the photovoltaic power units 100, 101 at night or in a bad-weather daytime and the photovoltaic power units 100, 101 do not generate power, power supplied from a power plant and the like via the super-conducting cable 9 is used as the power for the above pressure pump or the above circulating pump.

Here, the present invention is not limited to the descriptions of the above first to fourth embodiments, and it is possible to perform various modifications without departing from the spirit of the present invention for practical use. For example, the refrigerant for the super-conducting cable 9 is not limited to the liquefied gas, and another refrigerant may be used. Besides, at least part of the connection cables that connect the solar battery unit 1 and the conversion apparatuses (the inverter apparatus, the DC/DC converter and the like) to each other may be replaced with super-conducting cables. Besides, the 400 VAC transmission line 6 or the 400 VDC transmission line 6′ may be replaced with a super-conducting cable.

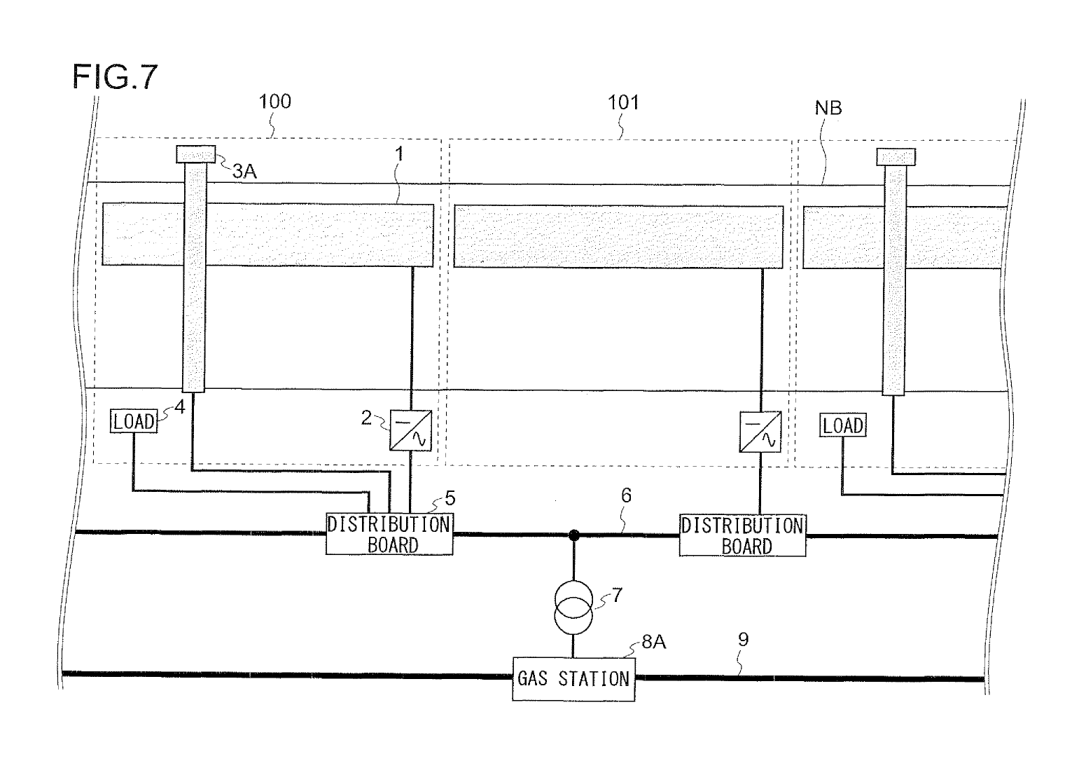

Next, a fifth embodiment of the present invention is described. A schematic structure of a photovoltaic power system according to the fifth embodiment of the present invention is shown in FIG. 7. Here, in FIG. 7, the same portions as those in FIG. 1 are indicated by the same reference numbers.

The photovoltaic power system according to the fifth embodiment of the present invention shown in FIG. 7 includes:

a plurality of the photovoltaic power units 100 each of which has: the solar battery unit 1; the inverter apparatus 2 that converts the d.c. voltage output from the solar battery unit 1 into the a.c. voltage; an illumination light 3A; the load (e.g., an illumination light and the like) 4; and

a plurality of the photovoltaic power units 101 each of which has: the solar battery unit 1; the inverter apparatus 2 that converts the d.c. voltage output from the solar battery unit 1 into the a.c. voltage. The photovoltaic power units 100, 101 are disposed, for example, on the sound-proof wall NB of an expressway along the longitudinal direction of the solar battery unit 1; a predetermined number (e.g., 9) of the photovoltaic power units 100 are consecutively arranged; one photovoltaic power unit 101 is interposed; and further, a predetermined number (e.g., 9) of the photovoltaic power units 100 are consecutively arranged, which is repeated.

Besides, the photovoltaic power system according to the fifth embodiment of the present invention shown in FIG. 7 includes: the distribution board 5 that is connected to the inverter apparatus 2, the illumination light 3A and to the load 4 of the photovoltaic power unit 100, or connected to the inverter apparatus 2 of the photovoltaic power unit 101; and the 400 VAC transmission line 6 that is connected to the inverter apparatus 2, the illumination light 3A, the load 4 of the photovoltaic power unit 100 and to the inverter apparatus 2 of the photovoltaic power unit 101.

Further, the photovoltaic power system according to the fifth embodiment of the present invention shown in FIG. 7 includes the transformer 7 having the rated capacity of 150 kVA that transforms the voltage from the 400 VAC transmission line 6 into the high voltage to supply the high voltage to the super-conducting cable 9, and transforms the voltage from the super-conducting cable 9 into the low voltage to supply the low voltage to the 400 VAC transmission line 6; a gas station 8A that supplies a liquefied gas (e.g., liquid nitrogen) which serves as a refrigerant to the super-conducting cable 9, and serves as an interface for the connection between a high-voltage side of the transformer 7 and the super-conducting cable 9; and the super-conducting cable 9 that is connected to the 400 VAC transmission line 6 via the gas station 8A. Here, the super-conducting cable 9 functions as a 22 kVAC transmission line.

In a case where the sunshine impinges on the solar battery unit 1 and the photovoltaic power units 100, 101 generate power in a good-weather daytime, the generated power from the photovoltaic power units 100, 101 successively passes through the distribution board 5, the 400 VAC transmission line 6, the transformer 7, the gas station 8A and the super-conducting cable 9, so that the generated power is transmitted to other power consuming places by the 400 VAC transmission line 6, the super-conducting cable 9 and the like. Here, in a case where the load 4 is a load that consumes power even in the good-weather daytime, power generated from the photovoltaic power unit 100 is transmitted to the load 4 as well. On the other hand, in a case where the sunshine does not impinge on the solar battery unit 1 and the photovoltaic power units 100, 101 do not generate power at night or in a bad-weather daytime, power from a power plant and the like successively passes through the super-conducting cable 9, the gas station 8A, the transformer 7, the 400 VAC transmission line 6, and the distribution board 5, so that the power is supplied to the illumination light 3A and the load 4.

Next, a structural example of the solar battery unit 1 that is used in the present embodiment, sixth and seventh embodiments described later is described with reference to FIG. 2. In the structural example shown in FIG. 2, the solar battery unit 1 has 75 high-voltage output thin-film solar battery modules M1 that has the open-circuit voltage of 240 V or higher; the 75 high-voltage output thin-film solar battery modules M1 are connected into the arrangement of a series number of 1 and a parallel number of 75; and the parallel direction of the high-voltage output thin-film solar battery module M1 is the longitudinal direction of the solar battery module 1. And, the solar battery unit 1 and the inverter apparatus 2 are connected to each other by a connection cable.

In the case where the solar battery unit is composed of the high-voltage output thin-film solar battery module, as in the structural example shown in FIG. 2, it is necessary to decrease the series number to prevent the open-circuit voltage of the solar battery unit from becoming larger than the upper limit of the predetermined range. Here, the predetermined range is set in accordance with the requirements of the conversion apparatus (e.g., the inverter apparatus) that converts the output voltage from the solar battery unit.

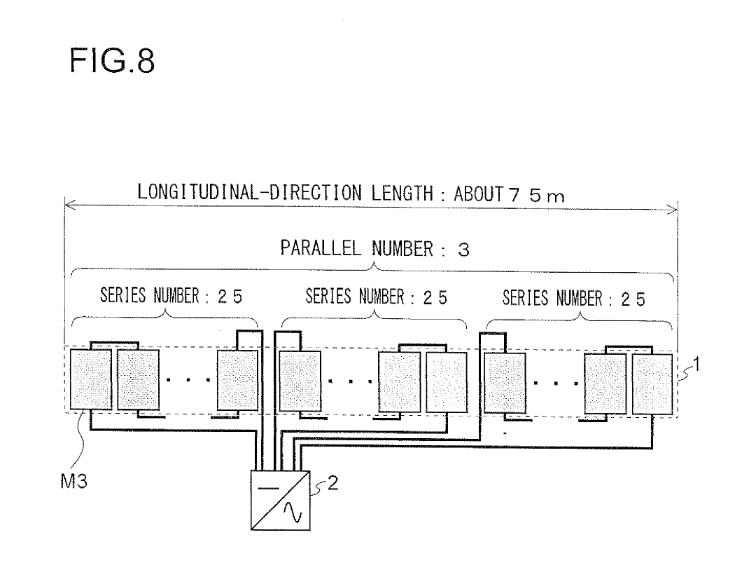

Another structural example of the solar battery unit 1 that is used in the present embodiment, the sixth and seventh embodiments described later is described with reference to FIG. 8. In the structural example shown in FIG. 8, the solar battery unit 1 has 75 crystalline solar battery modules M3; the 75 crystalline solar battery modules M3 are arranged in a line and the 75 crystalline solar battery modules M3 are connected into an arrangement with a series number of 25 and a parallel number of 3; and a direction in which the 75 crystalline solar battery modules M3 are arranged in a line is the longitudinal direction of the solar battery unit 1. And, the solar battery unit 1 and the inverter apparatus 2 are connected to each other by a connection cable.

In the case where the solar battery unit is composed of the crystalline solar battery module, as in the structural example shown in FIG. 8, it is necessary to increase the series number to prevent the open-circuit voltage of the solar battery unit from becoming smaller than the lower limit of the predetermined range. Here, the predetermined range is set in accordance with the requirements of the conversion apparatus (e.g., the inverter apparatus) that converts the output voltage from the solar battery unit.

In the structural example shown in FIG. 8, the 3 parallel groups in the solar battery unit 1 are arranged in a line, so that the arrangements of the connection cables that connect the solar battery unit 1 and the inverter 2 to each other become more than the structural example shown in FIG. 2; and the power loss increases more than the structural example shown in FIG. 2. Accordingly, the structural example shown in FIG. 2 is preferable than the structural example show in FIG. 8.

Next, the gas station 8A is described. The gas station SA has a pressure pump or a circulating pump (not shown) that supplies a liquefied gas (e.g., liquid nitrogen) to the super-conducting cable 9. In the photovoltaic power system according to the fifth embodiment of the present invention shown in FIG. 7, as power for the above pressure pump or the above circulating pump, power generated from the photovoltaic power units 100, 101 is used. In other words, the above pressure pump or the above circulating pump is supplied with the power from the high-voltage side of the transformer 7.

In a case where the load 4 is a load that consumes power even in a good-weather daytime, power generated from the photovoltaic power unit 100 is transmitted to the load 4 as well; however, the photovoltaic power unit 101 has no loads, so that there is not a risk that power is consumed by a load in the photovoltaic power unit. Because of this, by periodically disposing the photovoltaic power unit 101 like the photovoltaic power system according to the fifth embodiment of the present invention shown in FIG. 7, it is possible to secure the power for the above pressure pump or the above circulating pump with the power generated from the photovoltaic power unit 101.

However, in a case where the sunshine does not impinge on the solar battery unit 1 and the photovoltaic power units 100, 101 do not generate power at night or in a bad-weather daytime, power supplied from a power plant and the like via the super-conducting cable 9 is used as the power for the above pressure pump or the above circulating pump.

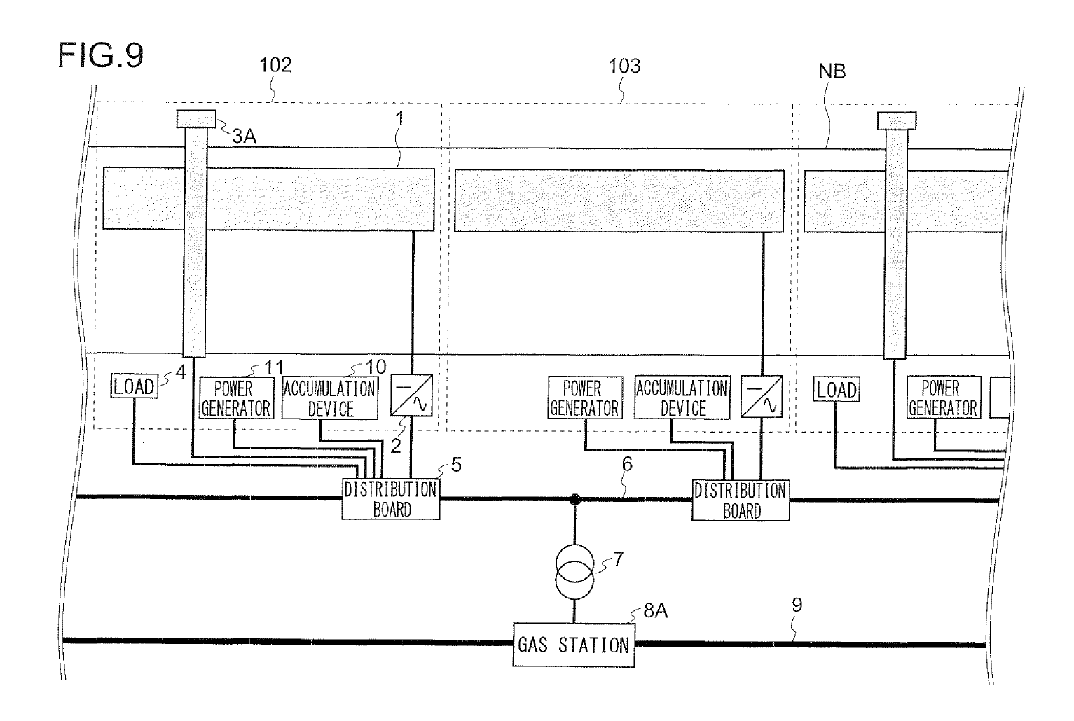

In the above photovoltaic power system according to the fifth embodiment of the present invention shown in FIG. 7, in a case where transmission trouble occurs in the 400 VAC transmission line 6 and the super-conducting cable 9, there is a problem that it is impossible to secure the power for the illumination light 3 and the load 4. A photovoltaic power system according to the six embodiment of the present invention that is able to solve the problem is shown in FIG. 9. Here, in FIG. 9, the same portions as those in FIG. 7 are indicated by the same reference numbers and detailed description is skipped.

The photovoltaic power system according to the sixth embodiment of the present invention shown in FIG. 9 has a structure in which in the photovoltaic power system according to the fifth embodiment of the present invention shown in FIG. 7, the photovoltaic power unit 100 is replaced with the photovoltaic power unit 102; and the photovoltaic power unit 101 is replaced with the photovoltaic power unit 103.

The photovoltaic power unit 102 has the structure in which the accumulation device 10 and the power generator (e.g., a Diesel-engine generator) 11 are added to the photovoltaic power unit 100; and the photovoltaic power unit 103 has the structure in which the accumulation device 10 and the power generator (e.g., the Diesel-engine generator) 11 are added to the photovoltaic power unit 101. The accumulation device 10 and the power generator 11 are connected to the distribution board 5 as shown in FIG. 9.

In the photovoltaic power unit 102, the accumulation device 10 accumulates the generated power from the solar battery unit 1; and supplies power to the illumination light 3A and the load 4 by discharge when the illumination light 3A and the load 4 consume power. Besides, the power generator 11 operates in a case where the accumulated power in the accumulation device 10 runs out. According to this, even in a case where transmission trouble occurs in the 400 VAC transmission line and the super-conducting cable 9, it is possible to secure the power for the illumination light 3A and the load 4.

In the photovoltaic power unit 103, the accumulation device 10 accumulates the generated power from the solar battery unit 1; and supplies power to the pressure pump of the gas station 8 or the circulating pump of the gas station 8 via the distribution board 5, the 400 VAC transmission line 6, and the transformer 7. Besides, the power generator 11 operates in a case where the accumulated power in the accumulation device 10 runs out. According to this, even in a case where transmission trouble occurs in the 400 VAC transmission line 6 and the super-conducting cable 9, as long as there is not transmission trouble in the connection route between the photovoltaic power unit 103 and the gas station 8, it is possible to secure the power for the pressure pump of the gas station 8 or the circulating pump of the gas station 8.

Here, in the system operation, if there is not a risk in effect that the accumulated power in the accumulation device 10 runs out, it is unnecessary to dispose the power generator 11, so that a structure, in which each photovoltaic power unit does not include the power generator 11, may be employed.

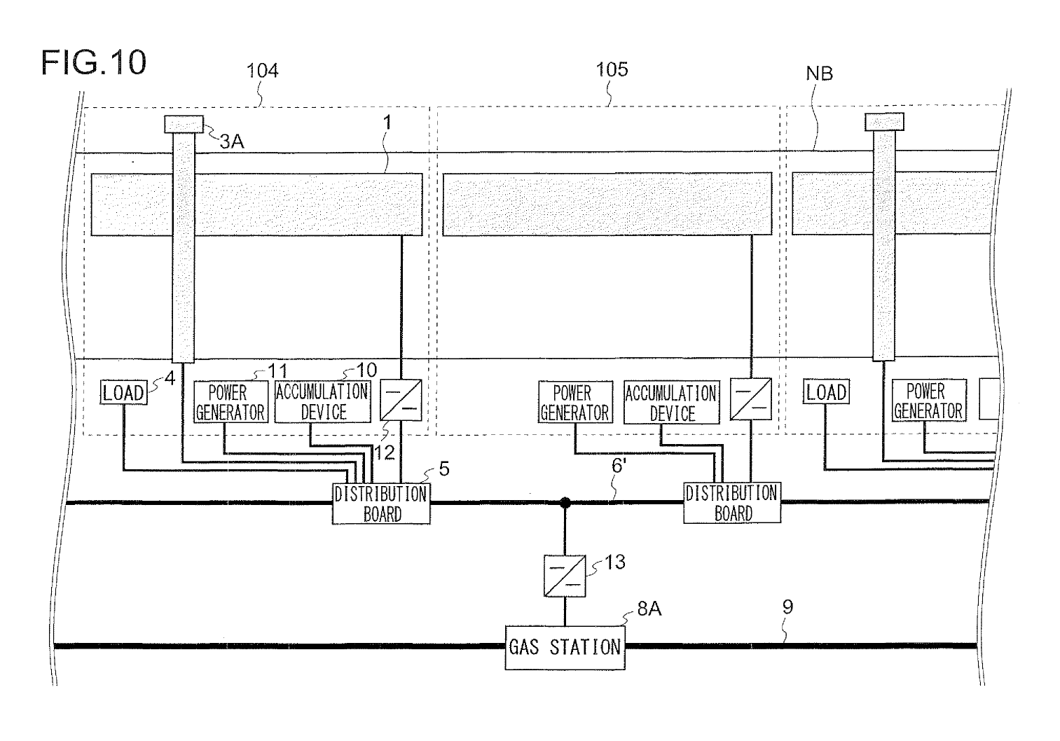

The above photovoltaic power systems according to the fifth and sixth embodiments employ the a.c. transmission; however, the d.c. transmission may be employed form the viewpoint for reducing the power loss. A photovoltaic power system according to a seventh embodiment of the present invention that employs the d.c. transmission is shown in FIG. 10. Here, in FIG. 10, the same portion as those in FIG. 9 are indicated by the same reference numbers and detailed description is skipped.

The photovoltaic power system according to the seventh embodiment of the present invention shown in FIG. 10 has a structure in which in the photovoltaic power system according to the sixth embodiment of the present invention shown in FIG. 9, the photovoltaic power unit 102 is replaced with the photovoltaic power unit 104; the photovoltaic power unit 103 is replaced with the photovoltaic power unit 105; the 400 VAC transmission line 6 is replaced with the 400 VDC transmission line 6′; and the transformer 7 is replaced with the DC/DC converter 13. Here, in the photovoltaic power system according to the seventh embodiment of the present invention shown in FIG. 10, the super-conducting cable 9 functions as the 22 kVDC transmission line.

The photovoltaic power unit 104 has the structure in which the inverter apparatus 2 of the photovoltaic power unit 102 is replaced with the DC/DC converter 12; and the photovoltaic power unit 105 has the structure in which the inverter apparatus 2 of the photovoltaic power unit 103 is replaced with the DC/DC converter 12.

In the photovoltaic power system according to the seventh embodiment of the present invention shown in FIG. 10, the accumulation device 10 receives the d.c. voltage, so that compared with the case of the photovoltaic power system according to the sixth embodiment of the present invention shown in FIG. 9, the specific structure of the accumulation device 10 becomes simple. On the other hand, in the photovoltaic power system according to the seventh embodiment of the present invention shown in FIG. 10, the power generator 11 needs to output the d.c. voltage, so that compared with the case of the photovoltaic power system according to the sixth embodiment of the present invention shown in FIG. 9, the specific structure of the power generator 11 becomes complicated.

Here, the present invention is not limited to the descriptions of the above fifth to seventh embodiments, and it is possible to perform various modifications without departing from the spirit of the present invention for practical use. For example, the refrigerant of the super-conducting cable 9 is not limited to the liquefied gas, and another refrigerant may be used. Besides, at least part of the connection cables that connect the solar battery unit 1 and the conversion apparatuses (the inverter apparatus, the DC/DC converter and the like) to each other may be replaced with super-conducting cables. Especially, in the case where the solar battery unit 1 has the structure shown in FIG. 8, the arrangements of the cables are many, so that it is useful to use super-conducting cables. Besides, the 400 VAC transmission line 6 or the 400 VDC transmission line 6′ may be replaced with a super-conducting cable.

### INDUSTRIAL APPLICABILITY

The photovoltaic power system according to the one aspect of the present invention is preferable for being disposed along a transmission line to generate power. Besides, the photovoltaic power system according to the other aspect of the present invention is preferable for consecutively disposing solar battery units along an expressway and the like to generate power.

### REFERENCE SIGNS LIST

1, 1′ solar battery unit
2 inverter apparatus
3 load
3A illumination light
4 load
5 distribution board
6 400 VAC transmission line
6′ 400 VDC transmission line
7 transformer
8 cooling station
8A gas station
9 super-conducting cable
10 accumulation device
11 power generator
12, 13 DC/DC converters
14 high-voltage transmission line
100 to 105 photovoltaic power units
M1 high-voltage output thin-film solar battery module
M2, M3 crystalline solar battery modules
NB sound-proof wall

1. A photovoltaic power system comprising:
a plurality of photovoltaic power units each of which includes:
a solar battery unit in which high-voltage output solar battery modules are connected in parallel with each other; and
a conversion portion that converts a direct-current voltage output from the solar battery unit; and
at least one transmission line which is disposed in parallel with the plurality of photovoltaic power units and to which each of the plurality of photovoltaic power units is connected.

2. The photovoltaic power system according to claim 1, wherein the high-voltage output solar battery modules are disposed in parallel with the transmission line.

3. The photovoltaic power system according to claim 1, wherein the transmission line is connected to a high-voltage transmission line.

4. The photovoltaic power system according to claim 1, wherein the photovoltaic power system interacts with a load or a power facility at a plurality of points via the transmission line or a high-voltage transmission line.

5. The photovoltaic power system according to claim 1, wherein an accumulator or a power facility is disposed in parallel with the solar battery unit.

6. The photovoltaic power system according to claim 1, wherein distribution control is performed by means of power from any of a system power supply and the solar battery unit via the transmission line.

7. The photovoltaic power system according to claim 5, wherein distribution control is performed by means of power from any of a system power supply, the solar battery unit, the accumulator and the power facility via the transmission line.

8. A photovoltaic power system comprising:
a plurality of photovoltaic power units each of which includes:
a solar battery unit in which a plurality of solar battery modules are are connected to each other; and
a conversion portion that converts a direct-current voltage output from the solar battery unit; and
one or more transmission lines which are disposed in parallel with the plurality of photovoltaic power units and to which each of the plurality of photovoltaic power units is connected;
wherein at least one of the transmission lines is a super-conducting cable.

9. The photovoltaic power system according to claim 8, further comprising a refrigerant supply apparatus that supplies a refrigerant to the super-conducting cable;
wherein as power for the refrigerant supply apparatus, the direct-current voltage output from the solar battery unit is used.

10. The photovoltaic power system according to claim 9, wherein
part of the plurality of photovoltaic power units are photovoltaic power units that have a load; and
the rest of the plurality of photovoltaic power units are photovoltaic power units that do not have a load.

11. The photovoltaic power system according to claim 8, wherein each of the plurality of photovoltaic power units includes an accumulation device.

12. The photovoltaic power system according to claim 8, wherein the conversion portion is an inverter apparatus.

13. The photovoltaic power system according to claim 8, wherein
one of the transmission lines is a first transmission line, and another of the transmission lines is a second transmission line;
wherein the second transmission line transmits a voltage higher than a voltage transmitted by the first transmission line, and is a super-conducting cable.

14. The photovoltaic power system according to claim 8, wherein the conversion portion is a DC/DC converter; and the transmission line is a direct-current transmission line.
